(19) United States
(12) Patent Application Publication
(10) Pub. No.: US 2007/0220453 A1
(43) Pub. Date: Sep. 20, 2007

(54) Method for forming reset operation verifying circuit

(76) Inventor: Hiroshi Tobita, Kanagawa (JP)

Correspondence Address: MCDERMOTT WILL & EMERY LLP, 600 13TH STREET, NW, WASHINGTON, DC, 20005-3096, US

(21) Appl. No.: 11/703,079

(22) Filed: Feb. 7, 2007

(30) Foreign Application Priority Data
Mar. 2, 2006 (JP) 2006-056460

(51) Int. Cl. G06F 17/50

(52) U.S. Cl. 716/1

(57) ABSTRACT

In a step 8, storage elements contained in sequential circuits are discriminated from each other with respect to circuit design data which contains the sequential circuit which is reset by an asynchronous reset signal and the sequential circuit which is not reset by the asynchronous reset signal. In a step 11 and a step 12, a flag circuit for indicating as to whether or not the storage element holds valid data is added to each of the storage elements. The flag circuit which is applied to the storage element of the sequential circuit which is not reset by the asynchronous reset signal is brought into an invalid display status which indicates that when the asynchronous reset signal is inputted, the storage element does not hold valid data.

### BACKGROUND OF THE INVENTION

1. Field of the Invention

The present invention is related to a technique capable of improving a logic circuit verifying method in the case that a verification subject circuit corresponds to an FPGA (Field Programmable Logic Array) where an asynchronous reset type sequential circuit is mixed with a synchronous reset type sequential circuit.

2. Description of the Related Art

In developing stages of semiconductor integrated circuits (LSIs), verification using software simulators, verification by prototype machines using FPGAs, and other verification are carried out. In general, in developing stages for developing large-scaled LSIs, partially small-scaled circuits are verified by employing software simulators; the verified small-scaled circuits are integrated and are written into FPGAs so as to construct large-scaled circuits; and then, designs of LSIs are verified by employing these FPGAs (refer to, for example, “COOL Chips VIII Proceedings” April in 2005, IEEE Computer Society and Yoshinao Kobayashi, “Tei-hon System Design for ASIC”, October in 1995, CQ publisher).

FIG. 9 is a flow chart for describing a general-purpose prototype verifying method using an FPGA. In FIG. 9, reference numeral 1 is a circuit data forming step; reference numeral 3 is a logic synthesizing step; reference numeral 4 is an FPGA writing step; and reference numeral 5 is a verification vector executing step for executing a verification vector by employing the written FPGA.

The above-explained verification with employment of the FPGAs owns such a merit that this verification can be carried out in a considerably high speed, as compared with the verification with employment of the software simulators. Although depending upon a verification subject circuit, verification using an FPGA may be executed within such an execution time which is shorter than an execution time of verification using a software simulator by 1/100,000.

As previously explained, although the verification using the FPGAs constitutes an attractive method, the software simulators have also been widely utilized due to some reasons. As one of these reasons why the software simulators are employed, the following reason may be conceived. That is, there is no means capable of constructing an asynchronous circuit in an FPGA in high precision required for verification.

As one example of these exemplifications, such a fact may be conceived that a resetting operation of a flip-flop employed in an FPGA cannot be completely made identical to a resetting operation of a flip-flop employed in an ASIC. Since an initial value of a flip-flop employed in an ASIC when a power supply thereof is turned ON cannot be predicted, this initial value is handled as an indefinite value in a software simulator. However, when flip-flops are mounted on an FPGA, such a condition that indefinite values have been entered to the respective flip-flops cannot be formed.

As to a problem which can be originally predicted when an initial value is handled as an indefinite value in a software simulator, since an indefinite value cannot be realized in an FPGA, there is a risk that the above-explained problem may be passed in verification using the FPGA. There are variable points when this restriction is removed and a total number of items which can be verified in the FPGA is increased.

Now, a description is made of resetting operations of flip-flops in an LSI. As to use modes of resetting signals in a synchronous circuit, there are two sorts of use modes, namely, a synchronous resetting mode and an asynchronous resetting mode. While a synchronous reset type circuit and an asynchronous reset type circuit own merits and demerits respectively, circuit designers selectively use these synchronous/asynchronous resetting type circuits in correspondence with features of circuits which are wanted to be realized (refer to, for instance, “RTL designing style guide VHDL edition”, May in 2004, Semiconductor Physical Engineering research center K.K.). Then, a synchronous reset type circuit and an asynchronous reset type circuit will now be explained as follows:

FIG. 12 indicates a mounting example of an asynchronous reset type circuit, and FIG. 13 represents operation waveforms of this asynchronous reset type circuit. In the asynchronous reset type circuit, a global network is arranged which supplies reset signals at the same time to a large number (for example, 1 thousand pieces) of flip-flops provided within an LSI.

This global network owns a large wiring line load, and may be easily and adversely influenced by noise. As a result, this global network has a demerit that the noise may readily cause erroneous operation. Also, since the reset signals are supplied through a large number of wiring lines, these reset signal wiring lines consume a large area on the LSI. As a consequence, higher cost is required. More specifically, in such a circuit that a large amount of flip-flops such as FIFOs are present, an increase of consumed areas thereof may give a large adverse influence.

FIG. 10 indicates amounting example of a synchronous reset type circuit, and FIG. 11 shows operation waveforms of this synchronous reset type circuit. In the synchronous reset type circuit, an initialization of flip-flops is performed without using reset terminals, but by entering initial values to data lines. As a consequence, in the synchronous reset type circuit, the reset signals do not constitute the global network, so that the above-explained drawbacks of the asynchronous reset type circuit can be solved. In other words, there is such a trend that the synchronous reset type circuit can resist noise and the consumed area thereof becomes small.

When flip-flops of a synchronous reset type circuit are initialized, circuits for entering initial values into these flip-flops must be designed by designers. Also, while clock cycle numbers required for performing initializations are determined specific to the respective circuits, designing mistakes may readily occur in initializing sequences in control circuits which require complex judgements as well as in a large-scaled circuit which is designed by a plurality of designers.

In large-scaled LSIs, there are many possibilities that synchronous reset type circuits and asynchronous reset type circuits are mixed with each other. More specifically, in such a case that established circuits (IP) are used and these established circuits are provided from a plurality of providers, there is no way to avoid the occurrence of such a problem. As a consequence, even in prototype verification using an FPGA, it is so important factor that resetting operation verification is carried out in high precision.

As previously explained, even in the case that such a circuit where sequential circuits which are reset by asynchronous reset signals and sequential circuits which are not reset by the asynchronous reset signals are mixed with each other is mounted on an FPGA, designing mistakes may easily occur in initializations of flip-flops, and thus, verification as to resetting operations may constitute the important aspect.

However, as previously explained, in the conventional prototype verification using the FPGA, such a condition that the indefinite values have been entered into the respective flip-flops cannot be made up. As a result, the problems which can be predicted when the initial values of the flip-flops are handled as the indefinite values by the software simulator cannot be predicted in the prototype verification, so that there is such a risk that problems of the resetting operations may be passed.

### SUMMARY OF THE INVENTION

The present invention has an object to provide a method for forming a reset operation verifying circuit capable of improving precision of prototype verification with employment of an FPGA, while even in the prototype verification using the FPGA, a resetting operation can be verified by making up such a status that infinite values have been entered into flip-flops.

A reset operation verifying circuit forming method, according to the present invention, is featured by comprising: a step for discriminating a storage element included in an asynchronous reset sequential circuit reset by an asynchronous reset signal, and a storage element included in a synchronous reset sequential circuit which is not reset by the asynchronous reset signal from each other with respect to circuit design data containing both the asynchronous reset sequential circuit and the synchronous reset sequential circuit; and a step for adding a flag circuit to each of the storage element, the flag circuit indicating as to whether or not the storage element thereof holds valid data. In accordance with the above-described arrangement, the storage elements contained in the sequential circuits in the design data of the FPGA are discriminated from each other, and also, the flag circuits for indicating as to whether or not the valid data are held are added with respect to the respective storage elements. As a result, when the flag circuit indicates that the storage element does not hold the valid data, it can be expressed in such a status that the infinite value has been entered to the storage element. Accordingly, such a problem which can be predicted when the infinite value is handled by the software simulator can also be realized even in the prototype verification using the FPGA, and the problem in the resetting operation can be detected.

In the present invention, the flag circuit added with respect to the storage element of the asynchronous rest sequential circuit is brought into such a status which indicates that when the asynchronous reset signal is inputted to the asynchronous reset sequential circuit, the storage element thereof holds the valid data. In accordance with the above-explained arrangement, the flag circuit added to the storage element of the asynchronous reset sequential circuit is immediately brought into the valid display status when the asynchronous reset signal is inputted, so that the resetting operation of the asynchronous reset sequential circuit can be displayed in a correct manner.

In the present invention, the flag circuit added with respect to the storage element of the synchronous rest sequential circuit is brought into such a status which indicates that when the asynchronous reset signal is inputted to the synchronous reset sequential circuit, the storage element thereof does not hold the valid data. In accordance with the above-explained arrangement, the flag circuit added to the storage element of the synchronous reset sequential circuit is brought into the invalid display status when the asynchronous reset signal is inputted. As a result, the flag circuit can display in a correct manner such a status that the infinite value has been entered while the synchronous reset sequential circuit is not reset.

In the present invention, such a circuit for outputting a status indicated by a flag circuit to an external terminal is added. In accordance with the above-explained arrangement, in the prototype verification using the FPGA, such a status of the flag circuit capable of realizing the status where the infinite value has been entered to the storage element can be monitored from the external terminal. As a result, the problem of the resetting operation can be easily detected.

In the present invention, such a circuit which produces a signal for representing that all of plural flag circuits hold the valid data, and outputs the produced signal to an external terminal is added. In accordance with the above-explained arrangement, in the prototype verification using the FPGA, such a signal which represents that all of the plural flag circuits are brought into the valid display statuses can be monitored from the external terminal. As a result, each of properly selected groups as to the synchronous reset sequential circuits can be monitored by a small number of the external terminals. Alternatively, all of the synchronous reset sequential circuits can be monitored by one pieces of the external terminal. Accordingly, the problem of the resetting operation can be easily detected, while a total number of verification-purpose external terminals is not considerably increased.

In accordance with the present invention, since the infinite value can be handled even in the FPGA, the problem which can be predicted when the infinite value is handled by the software simulator can be realized even in the prototype verification using the FPGA. As a consequence, the behavior of the circuit during the resetting operation can be handled, and the problem of the resetting operation can be detected in the prototype verification employing the FPGA.

### RRIEF DESCRIPTION OF THE DRAWINGS

FIG. 1 is a flow chart for explaining sequential operations of prototype verification using an FPGA, to which a method of forming a reset operation verifying circuit of the present invention has been applied.

FIG. 2 is a flow chart for indicating a method of forming a reset operation verifying circuit according to an embodiment mode of the present invention.

FIG. 3 is a diagram for indicating one example of an RTL description in which a reset operation verifying circuit has been added with respect to a verification subject circuit by the reset operation verifying circuit forming method of the present invention.

FIG. 4 is a circuit diagram for showing a structural example in which a reset operation verifying circuit has been added with respect to a synchronous reset type sequential circuit to be verified by way of the reset operation verifying circuit forming method of the present invention.

FIG. 5 is a diagram for showing operation waveforms in the structural example in which the reset operation verifying circuit has been added with respect to the synchronous reset type sequential circuit to be verified by way of the reset operation verifying circuit forming method of the present invention.

FIG. 6 is a circuit diagram for showing a structural example in which a reset operation verifying circuit has been added with respect to an asynchronous reset type sequential circuit to be verified by way of the reset operation verifying circuit forming method of the present invention.

FIG. 7 is a diagram for showing operation waveforms in the structural example in which the reset operation verifying circuit has been added with respect to the asynchronous reset type sequential circuit to be verified by way of the reset operation verifying circuit forming method of the present invention.

FIG. 8 is a circuit diagram for showing another structural example in which a reset operation verifying circuit has been added with respect to a synchronous reset type sequential circuit to be verified by way of the reset operation verifying circuit forming method of the present invention.

FIG. 9 is a flow chart for representing the conventional general-purpose prototype verifying method using the FPGA.

FIG. 10 is a circuit diagram for indicating the structural example of the synchronous reset type sequential circuit in the conventional FPGA prototype verification.

FIG. 11 is a diagram for representing operation waveforms of the synchronous reset type sequential circuit in the conventional FPGA prototype verification.

FIG. 12 is a circuit diagram for indicating the structural example of the asynchronous reset type sequential circuit in the conventional FPGA prototype verification.

FIG. 13 is a diagram for representing operation waveforms of the asynchronous reset type sequential circuit in the conventional FPGA prototype verification.

### DESCRIPTION OF THE PREFERRED EMBODIMENTS

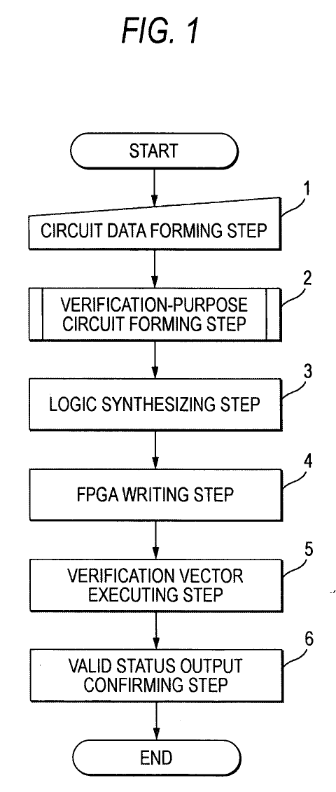

FIG. 1 is a flow chart for describing sequential operations as to prototype verification using an FPGA, to which a method of forming a reset operation verifying circuit according to an embodiment mode of the present invention has been applied. In FIG. 1, reference numeral 1 is a circuit data forming step; reference numeral 2 is a verification-purpose circuit forming step for verifying a resetting operation; reference numeral 3 is a logic synthesizing step; reference numeral 4 is an FPGA writing step for writing logically synthesized data; reference numeral 5 is a verification vector executing step for executing a verification vector by employing the written FPGA; and reference numeral 6 is a valid status output confirming step for confirming an output after the verification vector has been executed. As previously explained, first of all, the verification-purpose circuit for verifying the resetting operation before the FPGA is written is added to the circuit data, and validity of data contained in the circuit is judged after the verification vector is carried out, so that it is possible to verify as to whether or not a problem of the resetting operation in the prototype verification using the FPGA is present.

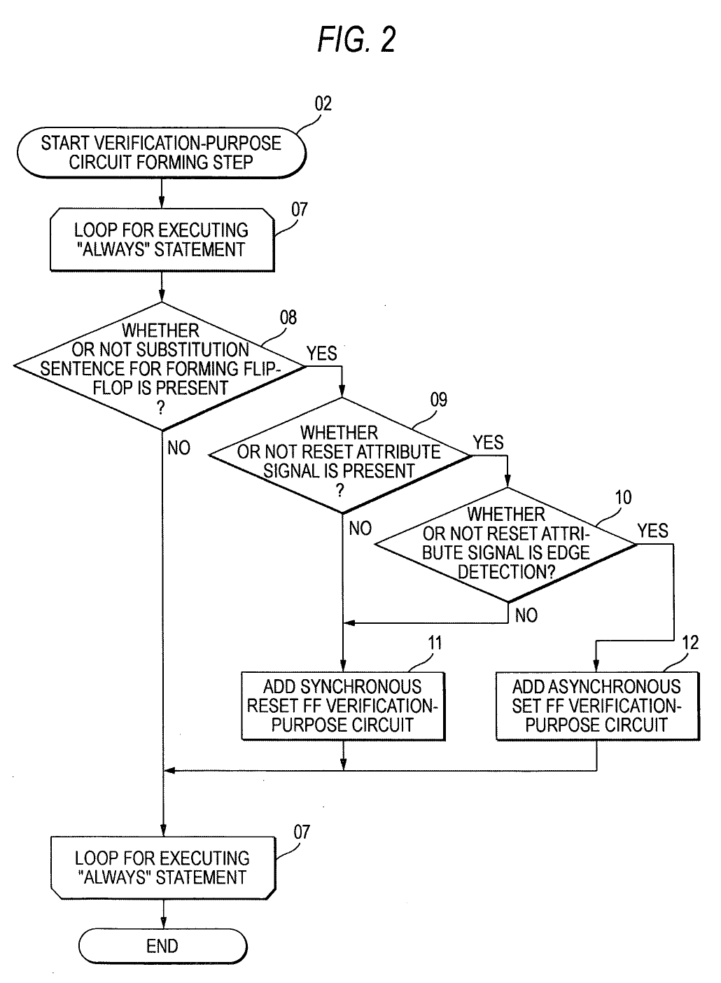

FIG. 2 is a flow chart for describing a detailed sequential operation as to the forming method of the reset operation verifying circuit executed in the verification-purpose circuit forming step 2. In FIG. 2, reference numeral 7 is a loop for executing an “always” statement; reference numeral 8 is a step for judging as to whether or not an insertion statement is present from which a flip-flop is produced; reference numeral 9 is a step for judging as to a reset attribute signal is present in the case that the flip-flop is produced; reference numeral 10 is a step for judging as to whether or not the reset attribute signal is an edge detection in the case that the reset attribute signal is present; reference numeral 11 is a synchronous reset FF (flip-flop) verification-purpose circuit adding step which is executed in such a case that the reset attribute signal is not present, or the reset attribute signal is not the edge detection; and reference numeral 12 is an asynchronous reset FF (flip-flop) verification-purpose circuit adding step which is executed in such a case that the reset attribute signal is present, and also the reset attribute signal is the edge detection. As previously explained, a judgement is made as to whether the verification subject circuit corresponds to a synchronous reset flip-flop, or an asynchronous reset flip-flop, and a proper reset operation verifying circuit is properly added in response to the verification subject circuit. As a result, the operation of this reset operation verification-purpose circuit is judged after the verification vector has been executed, so that the verification as to whether or not the problem of the resetting operation is present can be carried out in an effective manner by employing the FPGA.

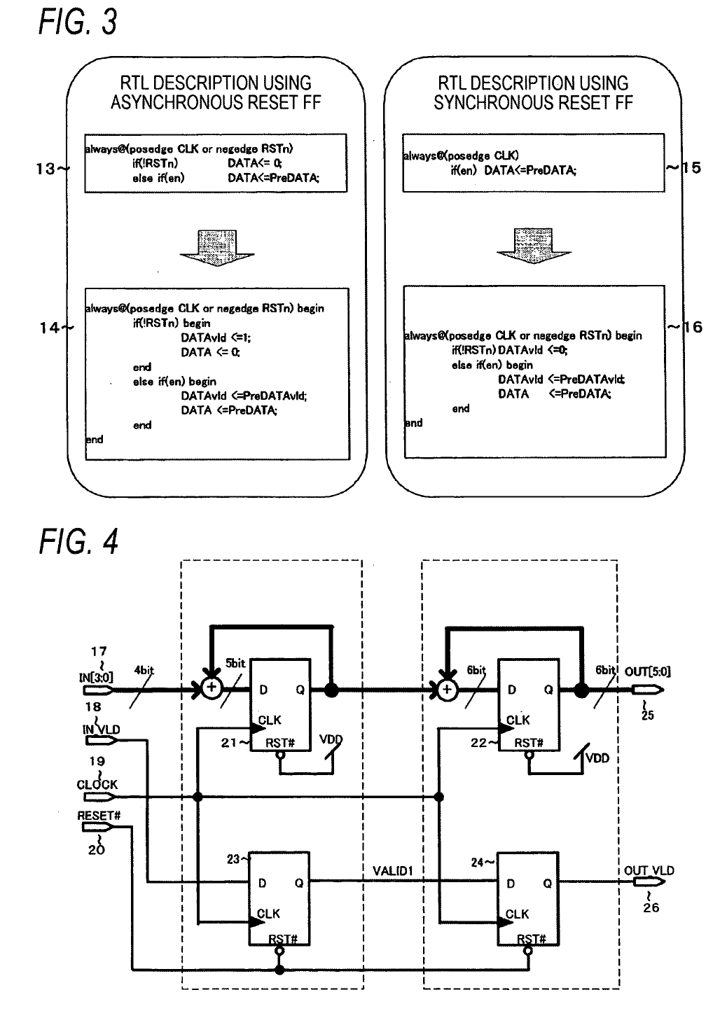

FIG. 3 is a diagram for indicating one example as to an RTL description of design data where a reset operation verifying circuit is added with respect to design data of a verification subject circuit by way of the method for forming the reset operation verifying circuit of the present invention. In FIG. 3, reference numeral 13 shows design data of a verification subject circuit using an asynchronous reset flip-flop; reference numeral 14 indicates design data after there set operation verifying circuit has been added with respect to the design data 13; reference numeral 15 represents design data of a verification subject circuit using a synchronous reset flip-flop; and reference numeral 16 indicates design data after the reset operation verifying circuit has been added with respect to the design data 15.

In the design data 14 and 16 after the reset operation verifying circuit has been added, with respect to flip-flop DATA which receives input data, “DATAvld” has been added as a flag for indicating as to whether or not the value thereof has been decided. When the flag “DATAvld” is equal to “0”, this flag represents such a status that the value of the flip-flop DATA is not yet decided but an indefinite value has been entered. When the flag “DATAvld” is equal to “1”, this flag represents such a status that the value of the flip-flop DATA has been decided.

As previously described, such a simple replacement is carried out, so that the resetting operation of the flip-flop can be verified. That is, in this simple replacement, the flags for indicating as to whether or not the values of the flip-flops have been decided are merely conducted with respect to the circuit design data of the asynchronous reset flip-flop and the synchronous reset flip-flop, which are described by the RTL description.

FIG. 4 is a circuit diagram for showing an example of an arrangement obtained after a reset operation verifying circuit has been added with respect to a synchronous reset type sequential circuit to be verified in accordance with the method for forming the reset operation verifying circuit of the present invention. In FIG. 4, reference numeral 17 is a data input; reference numeral 18 represents a flag indicative of a valid status of the data input 17; reference numeral 19 indicates a clock input; reference numeral 20 shows a reset input of a negative logic; reference numeral 21 shows a first-staged synchronous reset flip-flop which receives the data input 17; reference numeral 22 is a second-staged synchronous reset flip-flop which receives data of the flip-flop 21; reference numeral 23 is a first-staged asynchronous reset flip-flop which receives the flag 18 and holds a flag indicative of a valid status of the flip-flop 21; and reference numeral 24 shows a second-staged asynchronous reset flip-flop which receives the data of the flip-flop 23 and holds a flag indicative of a valid status of the flip-flop 22.

While reset input terminals of the synchronous reset flip-flops 21 and 22 are not used, the reset input 20 is connected to reset input terminals of the asynchronous reset flip-flops 23 and 24. With employment of this arrangement, the asynchronous reset flip-flops 23 and 24 are initialized as initial values “L” by the reset input 20, the synchronous reset flip-flops 21 and 22 express that just after the resetting operations, the synchronous reset flip-flops 21 and 22 are not initialized but hold indefinite values.

Also, since the flag 18 indicative of the valid status of the data input 17 is acquired by the flip-flop 23 for holding the flag, when the infinite value is also propagated from the data input 17, it is so expressed that the infinite value is held. With employment of this arrangement, the behavior when the synchronous reset type sequential circuit is reset may be properly expressed in the FPGA.

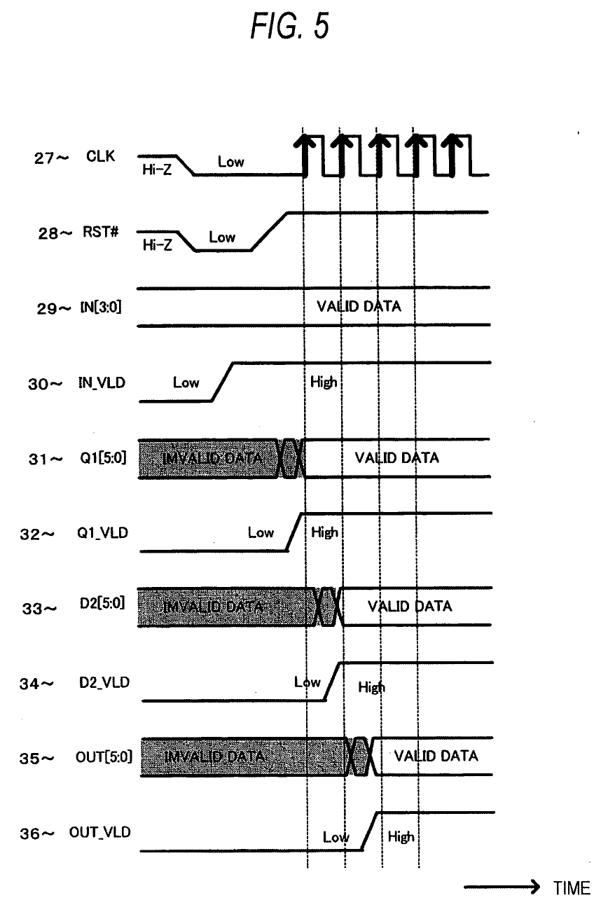

FIG. 5 is a diagram for representing operation waveforms in another example of an arrangement obtained after a reset operation verifying circuit has been added with respect to a synchronous reset type sequential circuit to be verified in accordance with the method for forming the reset operation verifying circuit of the present invention. In FIG. 5, reference numeral 27 indicates a clock signal; reference numeral 28 shows a reset input of a negative logic; reference numeral 29 shows a data input; reference numeral 30 indicates a flag indicative of a valid status of the data input 29; reference numeral 31 shows an output of a first-staged synchronous reset flip-flop; reference numeral 32 indicates a flag representative of a valid status of the flip-flop 31; reference numeral 33 shows an output of a second-staged synchronous reset flip-flop; reference numeral 34 indicates a flag representative of a valid status of the flip-flop 33; reference numeral 35 shows an output of a third-staged synchronous reset flip-flop; and reference numeral 36 indicates a flag representative of a valid status of the flip-flop 35.

In the synchronous reset type sequential circuit, even when the reset input 28 is asserted, in the case that valid data is not inputted, a valid value is not held. Also, even when the valid data is inputted, this valid data is not acquired unless a clock is supplied. As a consequence, even when the flag 32 for indicating the valid status of the first-staged synchronous reset flip-flop 31 remains at “L” even if the reset input 28 is asserted. Every time the clock is inputted, the valid data is propagated to the next-staged synchronous reset flip-flop, and values of flags for indicating the valid statuses of these synchronous reset flip-flops are also propagated to a next stage every time a clock is entered. As explained above, it can been understood that the propagation stages of the valid data of the synchronous reset type sequential circuits can be properly simulated.

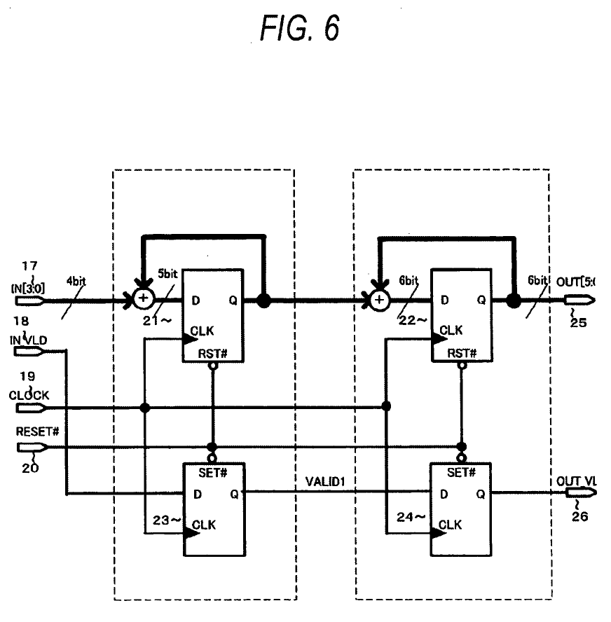

FIG. 6 is a circuit diagram for showing an example of an arrangement obtained after a reset operation verifying circuit has been added with respect to an asynchronous reset type sequential circuit to be verified in accordance with the method for forming the reset operation verifying circuit of the present invention. In FIG. 6, reference numeral 17 is a data input; reference numeral 18 represents a flag indicative of a valid status of the data input 17; reference numeral 19 indicates a clock input; reference numeral 20 shows a reset input of a negative logic; reference numeral 21 shows a first-staged asynchronous reset flip-flop which receives the data input 17; reference numeral 22 is a second-staged asynchronous reset flip-flop which receives data of the flip-flop 21; reference numeral 23 is a first-staged asynchronous reset flip-flop which receives the flag 18 and holds a flag indicative of a valid status of the flip-flop 21; and reference numeral 24 shows a second-staged asynchronous reset flip-flop which receives the data of the flip-flop 23 and holds a flag indicative of a valid status of the flip-flop 22.

A difference between the circuit arrangement of FIG. 6 and the circuit arrangement of FIG. 4 is given as follows: That is, since the flip-flops 21 and 22 are the asynchronous reset type sequential circuits, the reset input 20 is inputted to the reset terminals thereof, whereas with respect to the asynchronous reset flip-flops 23 and 24 which hold the valid statuses of these flip-flops 21 and 22, the reset input 20 is not entered to the reset terminals thereof, but the set terminals thereof.

In the above-explained arrangement, the asynchronous reset flip-flops 23 and 24 are initialized to initial values “H” by receiving the reset input 20. As a result, this fact expresses that the asynchronous reset flip-flops 21 and 22 are initialized just after the resetting operations, and hold finite values. Also, the flag 18 indicative of the valid status of the data input terminal is acquired by the flip-flop 23 which holds the flag, so that it is so expressed that when the infinite value is propagated from the data input 17, the flip-flop 23 holds the infinite value. With employment of this arrangement, the behavior when the asynchronous reset type sequential circuit is reset maybe properly expressed in the FPGA.

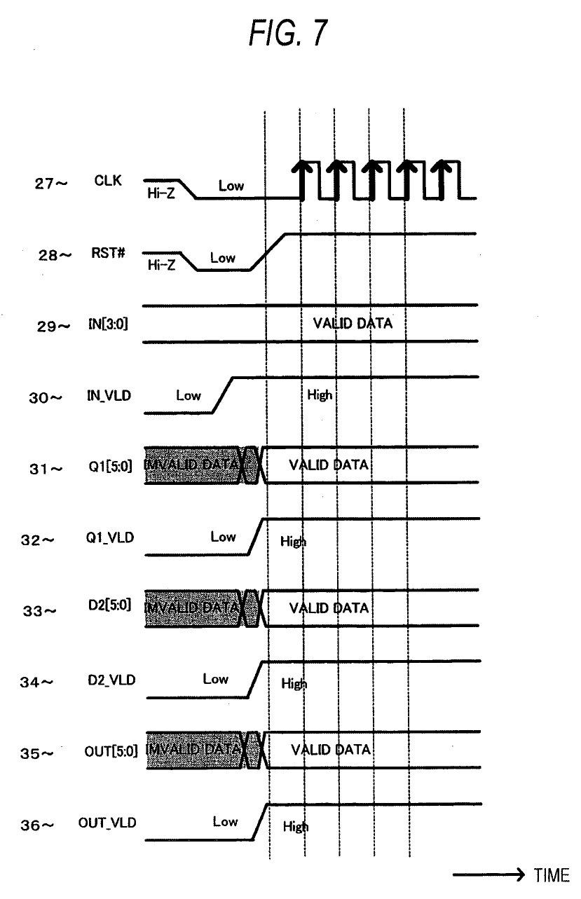

FIG. 7 is a diagram for showing operation waveforms in another example of an arrangement obtained after a reset operation verifying circuit has been added with respect to an asynchronous reset type sequential circuit to be verified in accordance with the method for forming the reset operation verifying circuit of the present invention. In FIG. 7, reference numeral 27 indicates a clock signal; reference numeral 28 shows a reset input of a negative logic; reference numeral 29 indicates a data input; reference numeral 30 represents a flag indicative of a valid status of the data input 29; reference numeral 31 is an output of a first-staged asynchronous reset flip-flop; reference numeral 32 is a flag indicative of a valid status of the flip-flop 31; reference numeral 33 is an output of a second-staged asynchronous reset flip-flop; reference numeral 34 is a flag indicative of a valid status of the flip-flop 33; reference numeral 35 is an output of a third-staged asynchronous reset flip-flop; and reference numeral 36 is a flag indicative of a valid status of the flip-flop 35.

In the asynchronous reset type sequential circuit, when the reset input 28 is asserted, at the same time, the asynchronous flip-flops are initialized and hold initial values as valid values. As a consequence, when the flag 32 indicative of the valid status of the first-staged asynchronous reset flip-flop 31, at the same time, this flag 32 becomes “H.” This condition may be similarly applied to the flags 34 and 36 which represent valid statuses of the second-staged asynchronous reset flip-flop 33 and the third-staged asynchronous reset flip-flop 35, respectively.

Every time the clock is inputted, the valid data is propagated to the next-staged asynchronous reset flip-flop, and values of flags for indicating the valid statuses of these asynchronous reset flip-flops are also propagated to a next stage every time a clock is entered. As explained above, it can been understood that the propagation stages of the valid data of the asynchronous reset type sequential circuits can be properly simulated.

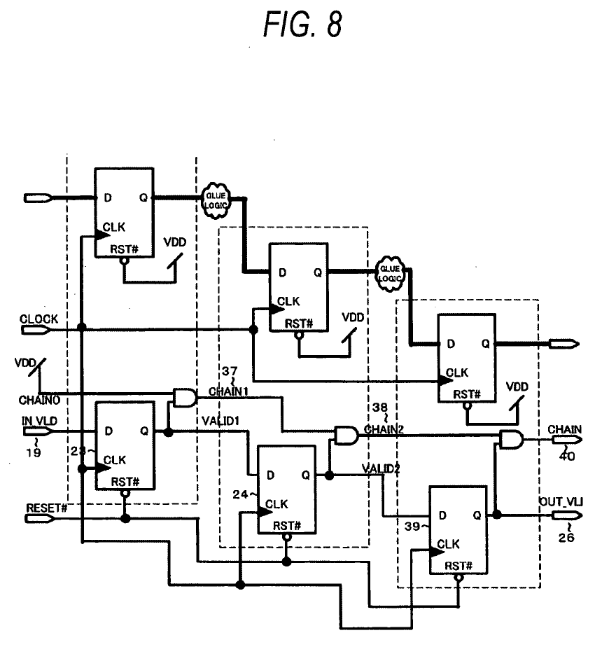

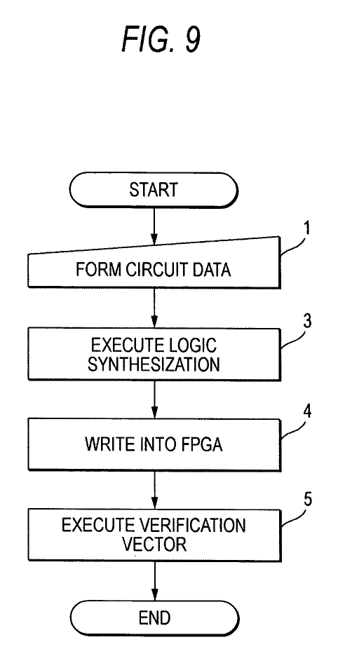

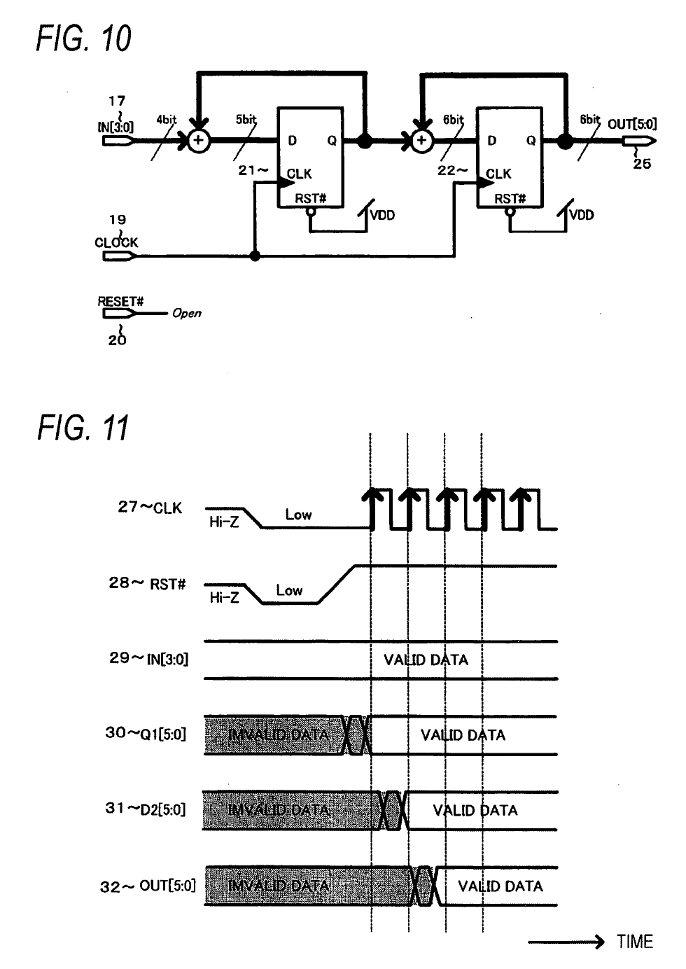

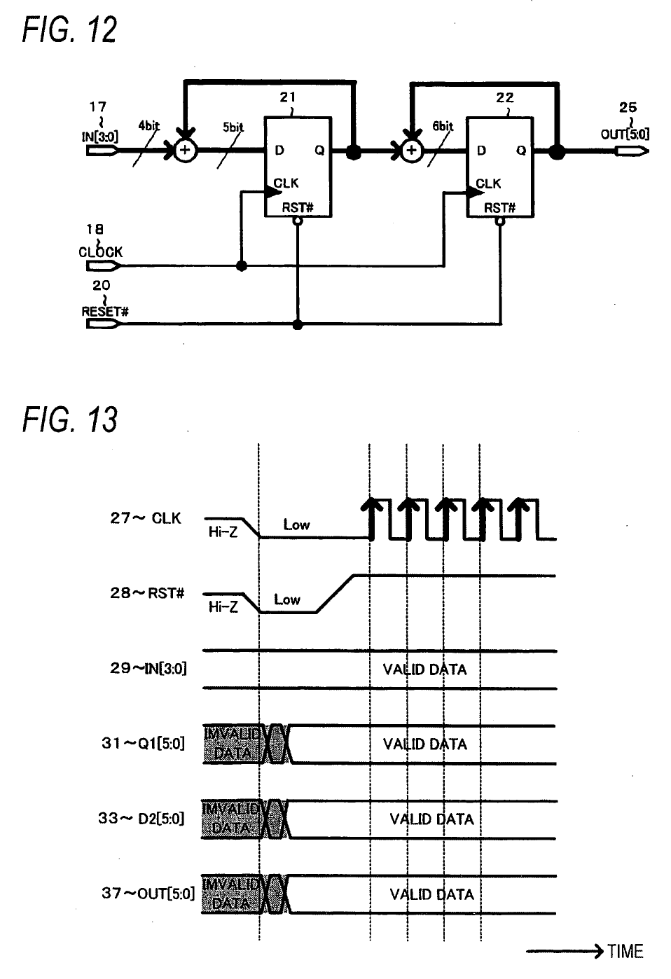

FIG. 8 is a circuit diagram for showing another example of an arrangement obtained after a reset operation verifying circuit has been added with respect to a synchronous reset type sequential circuit to be verified in accordance with the method for forming the reset operation verifying circuit of the present invention. This structural example is resembled to the circuit arrangement for indicating the operation waveforms in FIG. 5, and a chain network for reading out a value of a flag indicative of a valid status has been additionally provided. In FIG. 8, reference numerals 23, 24, and 39 indicate first-staged, second-staged, and third-staged asynchronous reset flip-flops which hold flags indicative of valid statuses of first-staged, second-staged, and third-staged synchronous reset flip-flops, respectively. Reference numeral 37 indicates a valid status reading-purpose chain network of a first-staged flag; reference numeral 38 is a valid status reading-purpose chain network of both the first-staged flag and a second staged flag; and reference numeral 4 is a valid status reading-purpose chain network output of the first-staged flag, the second-staged flag, and a third-staged flag.

A chain network is employed so as to sequentially apply a flag of each of these stages as an input of an AND-gated value. The chain network 37 corresponds to a value of the first-staged flag; the chain network 38 corresponds to an AND-gated value between the flag value of the chain net 37 and the flag value of the second-staged flag; and the chain network 40 corresponds to an AND-gated value between the flag value of the chain net 38 and the flag value of the third-staged flag. As a result, the chain network output 40 can be employed as an output which indicates a valid status of the entire circuit to be verified.

Normally, a total number of terminals which can be drawn outside a package of an FPGA is small, as compared with a circuit scale which can be mounted inside the FPGA. In this structural example, instead of such a structure that outputs of the respective flags are conducted to terminals, the entire flag valid statuses can be monitored by using one terminal. Also, since the flip-flops are connected to each other in a daisy chain system, there is such a merit that when the technology mapping operation is carried out with respect to the FPGA, no wiring line congestion status occurs, and a difficult synthesizing status occurred when the FPGA is utilized does not occur.

In accordance with the method for forming the reset operation verifying circuit of the present invention, while the FPGA capable of verifying the resetting operations in the considerably high speed is employed as compared with that of the software simulator, the occurrence and the propagation of the infinite value of the storage element contained in the sequential circuit can be simulated. As a consequence, the reset operation verifying circuit forming method can be usefully employed so as to verify such a large-scaled LSI that sequential circuits which are reset by asynchronous reset signals are mixed with sequential circuits which are not reset by the asynchronous reset signals.

What is claimed is:

1. A method of forming a reset operation verifying circuit, comprising the step of:
discriminating a storage element included in an asynchronous reset sequential circuit reset by an asynchronous reset signal, and a storage element included in a synchronous reset sequential circuit which is not reset by said asynchronous reset signal from each other with respect to circuit design data containing both said asynchronous reset sequential circuit and said synchronous reset sequential circuit; and
adding a flag circuit to each of said storage element, said flag circuit indicating as to whether or not said storage element thereof holds valid data.

2. The method of forming a reset operation verifying circuit as claimed in claim 1, further comprising the steps of:
bringing the flag circuit added with respect to the storage element of said asynchronous rest sequential circuit into such a status which indicates that when said asynchronous reset signal is inputted to said asynchronous reset sequential circuit, said storage element thereof holds the valid data.

3. The method of forming a reset operation verifying circuit as claimed in claim 1, further comprising the steps of:
bringing the flag circuit added with respect to the storage element of said synchronous rest sequential circuit into such a status which indicates that when said asynchronous reset signal is inputted to said synchronous reset sequential circuit, said storage element thereof does not hold the valid data.

4. The method of forming a reset operation verifying circuit as claimed in claim 1, further comprising the steps of:
adding a circuit which outputs the status indicated by said flag circuit to an external terminal.

5. The method of forming a reset operation verifying circuit as claimed in claim 1, further comprising the steps of:
adding a circuit which produces a signal for representing that all of plural flag circuits hold said valid data, and outputs said produced signal to an external terminal.

6. A computer program wherein:
said computer program causes a computer to execute said method of forming are set operation verifying circuit recited in claim 1.

7. A semiconductor integrated circuit wherein: the circuit formed by said method of forming a reset operation verifying circuit recited in claim 1 is added to said semiconductor integrated circuit.
